(19) United States
(12) Patent Application Publication
(10) Pub. No.: US 2026/0162914 A1
(43) Pub. Date: Jun. 11, 2026

(54) CIRCUIT BREAKER

(71) Applicants: Ellenberger & Poensgen GmbH, Altdorf (DE); R. Stahl Schaltgeraete GmbH, Waldenburg (DE)

(72) Inventors: Michael HILBERT, Braunschweig (DE); Hendrik-Christian KOEPF, Nuernberg (DE); Tobias KOPP, Hannover (DE); Enno PETERS, Braunschweig (DE); Holger SEMRAU, Satteldorf (DE)

(73) Assignees: Ellenberger & Poensgen GmbH, Altdorf (DE); R. Stahl Schaltgeraete GmbH, Waldenburg (DE)

(21) Appl. No.: 19/414,366

(22) Filed: Dec. 10, 2025

(30) Foreign Application Priority Data
Dec. 10, 2024 (DE) 10 2024 211 752.8

(51) Int. Cl. H01H 9/04; H01H 89/00

(52) U.S. Cl. CPC H01H 9/04; H01H 89/00

(57) ABSTRACT

A circuit breaker for operation in a potentially explosive environment. The circuit breaker comprises a hybrid switch which has a main current path with an isolating element and a secondary current path, connected in parallel to the main current path. A semiconductor switch and a control circuit are also provided. The isolating element and the semiconductor switch are actuated by the control circuit.

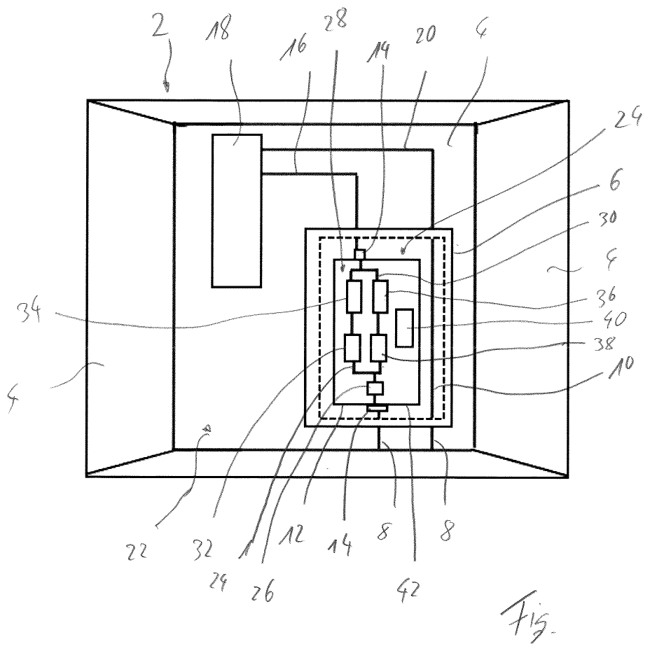

This nonprovisional application claims priority under 35 U.S.C. § 119(a) to German Patent Application No. 10 2024 211 752.8, which was filed in Germany on Dec. 10, 2024, and which is herein incorporated by reference.

### BACKGROUND OF THE INVENTION

### Field of the Invention

The invention relates to a circuit breaker and to the use of a circuit breaker. The circuit breaker has a hybrid switch with a main current path and a secondary current path connected in parallel to the main current path. In addition, the invention relates to a chamber.

### Description of the Background Art

Electric power is increasingly being generated from renewable energy sources, such as solar energy or wind power. Because these are not available continuously or when they are needed, storage solutions are required. One possibility is to produce hydrogen gas using electricity and to store it. It is also possible to use the hydrogen gas produced in this way for other purposes, such as, for example, the enrichment of natural gas or for the operation of motor vehicles. However, relatively high electric currents are required to produce hydrogen gas from electricity, particularly by means of electrolysis.

In the event of a short circuit in an actuator or damage to a line used for the electric supply to the actuator, an overcurrent can occur, which can lead to further damage to the actuator or to impacts in the electrical supply network by means of which the actuator is operated. It is therefore necessary to interrupt this overcurrent relatively quickly. A circuit breaker is usually used for this purpose, which is connected to the electric line by which the respective actuator is supplied with current. If an overcurrent occurs in the line, therefore, the electric current carried by the line is greater than a certain limit value, the circuit breaker is activated, so that the electric current flow through the line and thus also to the actuator is prevented.

A circuit breaker usually has a switching element which is triggered depending on a signal provided by a sensor. It is possible in this case for the sensor and the switching element to be present as a common unit, such as, for example, a bimetallic snap disk. In the current-conducting/closed state, the bimetallic snap disk is in contact with a mating contact and the electric current is conducted via it. If the electric current is greater than the limit value, the bimetallic snap disk is heated to varying degrees and therefore bent. Due to the bending, the bimetallic snap disk moves away from the mating contact, so that the electric current is interrupted. If the electric current conducted by the circuit breaker is relatively high and the electric voltage used is greater than 60 V, for example, it is possible that an arc will form between the bent bimetal snap disk and the mating contact, via which arc an electric current will continue to be conducted.

If such a circuit breaker is used in the production of hydrogen gas and is not designed to be gas-tight, it is possible that the hydrogen gas that has penetrated the circuit breaker will ignite. To remedy this, the circuit breaker is usually located outside the chambers in which the hydrogen gas is present, usually in a separate connection chamber of an industrial plant for the production of hydrogen gas. Thus, relatively long lines are required, which is why manufacturing costs and proneness to faults are increased. It is also more complicated to restart the actuator after the circuit breaker has tripped, because the actuator and its reaction cannot be visually inspected when the circuit breaker is returned to the electrically conductive state.

An alternative to this is to make the circuit breaker gas-tight and place it in the chamber with the actuator. If an arc occurs in the circuit breaker, the pressure in the circuit breaker increases, at least locally, but by more than 10 bar. In this regard, it is necessary for the circuit breaker to remain gas-tight even at such high pressures, which increases the requirements for the housing of the circuit breaker. Thus, the size and manufacturing costs of the circuit breaker are increased.

WO 2010/108565 A1, which corresponds to US 2012/0007657, which is incorporated herein by reference, and which discloses a hybrid switch (hybrid switch disconnector) with a mechanical switch or isolating element and semiconductor electronics connected in parallel therewith, which comprises a semiconductor switch, preferably an IGBT. The semiconductor electronics has no additional energy source and blocks a current when the mechanical switch is closed, i.e., practically without current and voltage. The mechanical switch is opened to interrupt the current via the hybrid switch, whereby an electric arc can occur. The energy of the arc created when the mechanical switch is opened is used by the semiconductor electronics, wherein the semiconductor electronics is connected to the mechanical switch in such a way that when the mechanical switch opens, the arc voltage switches the semiconductor switch to be conducting via the mechanical switch (as a result of the arc).

As soon as the semiconductor switch is switched to be conducting, the electric current begins to commutate from the mechanical switch to the semiconductor switch. The corresponding arc voltage or arc current additionally charges an energy storage device in the form of a capacitor, which is used to provide control voltage for the semiconductor electronics. As soon as the electric current is commutated to the semiconductor switch, the arc goes out and the charging process of the energy storage device is completed. An ionized gas that has formed due to the arc and is broken down over time is located between the switching contacts of the mechanical switch. Following the charging process, a timer starts, during which the semiconductor switch continues to be kept current-conducting by the energy storage device. After the time period of the timer has elapsed, the semiconductor switch is again switched to be non-conducting.

### SUMMARY OF THE INVENTION

It is therefore an object of the present invention to provide a particularly suitable circuit breaker, a particularly suitable chamber, and a particularly suitable use of a circuit breaker, wherein production costs are expediently reduced and/or safety is increased.

In an example, the circuit breaker can be used to electrically protect a line and/or an actuator that is energized by one or the line during operation. In particular, the circuit breaker is electrically contacted with the line and is suitable, in particular provided and configured, for this purpose. Expediently, the circuit breaker has one or preferably two terminals that are suitable, in particular provided and configured, so that an electric line is connected to each of them. For example, the terminals are designed in the form of receptacles for a busbar, cable lugs, or insulation displacement contacts.

In particular, the circuit breaker is provided and configured to interrupt the electric current flow conducted through it electrically in the event of a conducted overcurrent that is, for example, four times a rated current, therefore, the electric current conducted by the circuit breaker in normal operation. Expediently, the circuit breaker comprises a sensor for detecting the electric current carried by it, so that the overcurrent can be determined. The circuit breaker can be provided and configured to detect a short-circuit current of up to 10,000 A or a so-called “arc” that occurs in the actuator/line and subsequently to interrupt the electric current flow via the circuit breaker.

For example, the circuit breaker can be designed in such a way that the electric current conducted through it is interrupted if it exceeds a limit value. The limit value is, for example, static, adapted to the specific application, or time-dependent. For example, the interruption occurs as soon as the limit value has been exceeded, or only when the limit value has been exceeded for a certain period of time. For example, the circuit breaker has a control input, and based on the signals received via the control input, the circuit breaker is, for example, brought into the electrically conductive or the electrically non-conductive state. It is thus possible to control the circuit breaker remotely, therefore, to operate it from a distance, which increases convenience.

For example, the circuit breaker is suitable, in particular provided and configured, so that an electric voltage is applied to it that is greater than 220 V or 500 V and, for example, is less than 2000 V if the circuit breaker is electrically non-conductive. The circuit breaker is expediently used to protect an electric voltage between 400 V and 1500 V and, for example, of 650 V and 800 V and is suitable, provided, and/or configured for this purpose.

For example, the circuit breaker can be inserted into an alternating current system, so that an alternating current is conducted through the circuit breaker during operation. However, the circuit breaker is used particularly preferably in a direct current system and thus serves to protect a direct current circuit. In other words, a direct current is conducted by means of the circuit breaker during normal operation. The electric current conducted by the circuit breaker in normal operation is suitably greater than 10 A, 20 A, or 50 A. In particular, the rated current, therefore, the maximum electric current conducted by the circuit breaker in normal operation, is less than 200 A or 150 A.

The circuit breaker is suitable for safe operation in a potentially explosive environment and is provided and configured for this purpose. In other words, the intended application of the circuit breaker is in a potentially explosive environment. Therefore, when the circuit breaker is in operation, there may be, for example, a (highly) flammable and/or potentially explosive gas such as, for example, hydrogen gas (H2), which is especially mixed with oxygen gas (O2), in its vicinity, therefore, adjacent to it. Alternatively or in combination with this, there may be gasoline vapors or other easily flammable gases or dust in the vicinity of the circuit breaker. In an alternative, the circuit breaker when mounted is arranged, for example, in a flammable/explosive liquid. If a spark is present, especially due to local excessive heating, the gas/dust in the vicinity of the circuit breaker explodes unintentionally or at least ignites. The circuit breaker can be used for operation in a potentially explosive atmosphere in accordance with “Directive 1999/92/EC on minimum requirements for improving the safety and health protection of workers potentially at risk from explosive atmospheres.”In this regard, the circuit breaker preferably meets the requirements for use in a zone 0 or 20. Alternatively, the circuit breaker suitably only fulfills the requirements for use in a zone 1 or 21. For example, the circuit breaker only meets the requirements for use in a zone 2 or 22.

The circuit breaker can be designed in such a way that there is no local heating of the surroundings, so that even if an electric current flowing through the circuit breaker is interrupted, there is no ignition of the gases or other explosive substances located in the vicinity of the circuit breaker.

The circuit breaker has a hybrid switch, which is a disconnecting device, therefore, a switch unit/switching unit. If the circuit breaker is electrically conductive, the hybrid switch is also electrically conductive and the electric current is conducted by means of it during operation. If the circuit breaker is electrically non-conductive, the hybrid switch is also electrically non-conductive. Expediently, the hybrid switch is controlled on the basis of the signals provided by any sensors, so that the circuit breaker functionality is provided

The hybrid switch has a main current path, which is formed in particular between the two terminals of the circuit breaker or at least connected between them. The main current path has an isolating element that can be actuated. It is possible here to place it in a closed state, in which the main current path in particular is low-resistance, so that in particular a current flow between the two ends of the main current path, expediently between the two terminals, is possible. In an open state, in contrast, the isolating element is designed with a high resistance, so that a current flow via the main current path is essentially not possible, or at least an increased ohmic resistance prevails. In summary, the isolating element is in particular electrically conductive in the closed state and electrically non-conductive in the open state.

Expediently, the isolating element is a galvanically isolating component provided it is open. The isolating element is expediently a mechanical switch, such as a relay, a contactor, or a plug, or comprises at least one of these. Alternatively, the isolating element is designed as an overvoltage protection device. The isolating element is particularly suitable, preferably provided and configured, for carrying out a galvanic isolation of the main current path when it is opened, therefore, when brought into the open/opened state.

The hybrid switch further has a secondary current path that comprises a semiconductor switch. In particular, the semiconductor switch is connected in parallel to the isolating element, so that the isolating element is bridged by means of the semiconductor switch. Alternatively, for example, other components of the main current path are bridged by the semiconductor switch. The semiconductor switch is expediently a power semiconductor switch and preferably a field-effect transistor, such as a MOSFET, or an IGBT, or GTO. In particular, in normal operation, therefore, when current is to flow via the hybrid switch, the semiconductor switch is non-conductive. Thus, the electrical losses of the circuit breaker are relatively low during operation. When the semiconductor switch is in an open state, it has a high impedance so that a current flow through it is essentially not possible. In other words, the semiconductor switch is electrically non-conductive in the open state. In a closed state of the semiconductor switch, the semiconductor switch has a low resistance and is therefore electrically conductive.

The circuit breaker further has a control circuit by means of which the isolating element and the semiconductor switch are actuated. In other words, the control circuit is provided and configured to actuate the isolating element and the semiconductor switch, so that they are set to the electrically conductive or electrically non-conductive state. In particular, for actuation a specific electric voltage is applied to each control input. The isolating element and/or the semiconductor switch are expediently actuated by the control circuit when a current flow via the circuit breaker is to be interrupted. In particular, the control circuit is connected to any sensor in terms of signals, and the signals provided by the sensor are evaluated by the control circuit during operation.

The control of the isolating element/semiconductor switch can occur based on an interconnection of the control circuit. The interconnection in this case is made up of discrete components, for example, such as electric components, therefore, for example, resistors, capacitors, diodes, or inductors. Preferably, the control circuit comprises an application-specific circuit (ASIC) and is formed, for example, by means of this. Alternatively or in combination therewith, the control circuit can have a computer, which is suitably designed to be programmable.

If the circuit breaker is electrically conductive, therefore, an electric current is to be conducted by it, the isolating element in particular is electrically conductive and the semiconductor switch is electrically non-conductive. These are expediently controlled accordingly by the control circuit. If the electric current flow through the circuit breaker is to be interrupted, in particular if an event to be triggered is present, such as, for example, the presence of an overcurrent, short-circuit current, or an arc, the isolating element is expediently opened by means of the control circuit and the semiconductor switch is closed (at least briefly).

For example, to interrupt the current flow through the circuit breaker, the semiconductor switch is first closed, so that an electric current flow can commutate from the main current path to the secondary current path. The isolating element is then opened, wherein due to the electrically conductive current path, an arc does not form when the isolating element is opened. The semiconductor switch is then opened, therefore, brought into the electrically non-conductive state, so that the current flow via the secondary current path is also interrupted. The circuit breaker is thus subsequently transferred to the electrically non-conductive state, whereby no arc was formed. In this way, there is also essentially no or only slight heating of the circuit breaker. Thus, a flammable/explosive gas present cannot ignite.

Alternatively, the isolating element is opened first, for example, whereby an electric arc can form. Thus, an (unintentional) electric current flow continues via the main current path. The electric voltage that drops across the isolating element due to the existing arc is used in particular to place the semiconductor switch into the electrically conductive state, so that the electric current flow from the main current path to the secondary current path is commutated and the electric current flow via the main current path is interrupted. In particular, before the semiconductor switch is closed, an energy storage device is charged by means of the electric voltage that drops across the isolating element. By means of the energy stored in the energy storage device, the semiconductor switch is controlled to be electrically conductive for a short period of time after the arc collapses in the isolating element. When the arc is interrupted and the energy storage device is discharged, the semiconductor switch is placed in the electrically non-conductive state, wherein the arc in the isolating element is not re-ignited due to the cooling occurring in the meantime. With such a design, in particular no additional power supply is required for the control circuit.

The control circuit can be designed in such a way that, for example, the isolating element is opened first, whereby the arc can form. In particular, the isolating element is designed in such a way that the longer the isolating element is open, the more the electric voltage required to maintain the arc increases. After a certain time window, the semiconductor switch is placed in the electrically conductive state, so that the electric current commutates from the main current path to the secondary current path. Thus, the arc collapses. As soon as this is substantially completed, the semiconductor switch is opened again substantially immediately and the electric current flow is thus interrupted. In this case, the time window is selected in such a way that, despite the relatively fast reopening of the semiconductor switch, the arc is not re-ignited due to the relatively high electric voltage required to form the arc.

In each of the above options for interrupting the flow of electric current, the duration of any arc is relatively short and heating is only localized and limited. Due to the use of the hybrid switch in the circuit breaker, a load on the environment, therefore, an in particular local heating, is therefore relatively low, so that even if explosive substances, in particular gases, are present in the vicinity of the circuit breaker, they will not ignite. This enables safe operation of the circuit breaker even in such an environment, wherein the requirements for isolating the isolating switch from the explosive gases are relatively low. Thus, manufacturing costs are reduced. Because it can also essentially be ruled out that ignition of explosive/flammable gas occurs in the environment, safety during operation of the circuit breaker is increased. In this case, due to the main current path with the isolating element, the electrical losses occurring during operation of the circuit breaker are relatively low, and the semiconductor switch is only used in particular to conduct current if the current flow is to be interrupted. Thus, the requirements for the semiconductor switch are relatively low, which is why manufacturing costs as well as operating costs are reduced.

Expediently, the circuit breaker can have a mechanical actuation, such as a lever, which can be used in particular to change the (switching) state of the circuit breaker, therefore whether it conducts or does not conduct current. In particular, the control circuit is operated at least partially as a function of the mechanical actuation. Consequently, the field of application of the circuit breaker is broadened.

In particular, the circuit breaker can have a housing by means of which the isolating element, the semiconductor switch, and the control circuit are enclosed. The housing thus protects them mechanically, which facilitates the installation of the circuit breaker. In particular, the housing is designed to be rigid and made of plastic, for example. Thus, manufacturing costs are reduced. For example, the housing is designed to be pressure-resistant, so that the inside of the housing and the outside of the housing are separated from each other in terms of pressure. Consequently, it is possible that there is a pressure difference between them. Expediently, the housing is therefore not gas-permeable, thus gas-tight. For example, the compressive strength is less than 1 bar. If the overpressure in the housing is therefore greater than 1 bar, damage to the housing occurs, for example. Due to such a low compressive strength, the requirements for the housing are reduced, which is why manufacturing costs are lowered.

For example, the housing can be enclosed in a pressure-resistant manner. Safety is thus increased. However, it is particularly preferred that the housing is not enclosed in a pressure-resistant manner. In other words, the housing thus does not meet the requirements of the European standard “EN 60079-1 Explosive atmospheres” in particular, and expediently not part 1 “Equipment protection by flameproof enclosure “d”” of this standard. In this way, the requirements for the housing and therefore the manufacturing costs are reduced. Certification is also not required, which in turn reduces manufacturing costs. Preferably, the housing can also be gas-permeable. Thus, a gas exchange is possible between the inside of the housing and the outside of the housing, which is why heat dissipation from the housing to the environment is made possible. Preferably, the housing has multiple openings, such as slits, so that gas exchange is made uniform. Thus, for example, the circuit breaker, in particular the isolating element/semiconductor switch, is not excessively heated during operation. In this regard, the isolating element and the semiconductor switch in particular are controlled in such a way that no arc forms when the current flow is interrupted, or at least the control is such that any arc that occurs and the local heating are not sufficient to ignite the gas from the environment, which has in particular partially penetrated the housing. The control circuit is expediently designed for this purpose. In summary, in particular because the hybrid switch is present, an interruption of current flow through the circuit breaker is enabled without an arc being formed, so that no ignition of the gas occurs despite the non-pressure-resistant enclosing of the housing.

For example, the secondary current path only has the semiconductor switch. Particularly preferably, however, the secondary current path comprises an additional isolating element that is electrically connected in series to the semiconductor switch. For example, the additional isolating element is structurally identical to the isolating element or different. In particular, the additional isolating element is galvanically isolating, which increases safety. A galvanic isolation of the secondary current path is therefore made possible due to the additional isolating element, which is why the entire switch is galvanically isolating. Safety is thus increased further.

For example, the additional isolating element can be a mechanical switch and, expediently, a relay. The additional isolating element is also actuated by the control circuit. Suitably, during operation, the additional isolating element is always closed before the semiconductor switch is closed, and the additional isolating element is always opened only after the semiconductor switch is opened. Thus, an arc is never formed in the additional isolating element, because the switching state is only changed when no electric current flows via the secondary current path. The control circuit is expediently suitable and, in particular, is provided and configured for this purpose. For example, the corresponding actuation of the additional isolating element takes place due to a corresponding interconnection of the control circuit.

For example, the main flow path may only have the isolating element. Particularly preferably, however, the main current path comprises an additional semiconductor switch which is, for example, structurally identical to the semiconductor switch or, expediently, different from it. In particular, in this case, electrical losses are prevented in the additional semiconductor switch compared to the semiconductor switch when conducting the electric current, whereby, for example, a switching capability of the additional semiconductor switch is reduced compared to the semiconductor switch, which is why manufacturing costs are reduced. The additional semiconductor switch is electrically connected in series to the isolating element and actuated by the control circuit. When the circuit breaker conducts (is desired to conduct) current, the additional semiconductor switch and the isolating element are electrically conductive, therefore, closed in each case. To interrupt the electric current flow through the circuit breaker, the semiconductor switch is first closed, so that the electric current commutates at least partially from the main current path to the secondary current path. The additional semiconductor switch is then opened, so that the current flow through the main current path is completely interrupted. In this case, the electric voltage across the additional semiconductor switch is relatively low. Only then is the isolating element opened, whereby formation of an arc is not possible due to the already interrupted current flow. In addition, the semiconductor switch is actuated and the electric current flow via the secondary path is interrupted. The time at which the isolating element opens is hereby independent of the time at which the semiconductor switch opens. With this type of control, the use of the circuit breaker is also possible in the vicinity of highly flammable gases which ensures that an arc is not formed.

The chamber can be filled with an explosive atmosphere. For example, the atmosphere is a gas, the gas, for example, being a mixture of hydrogen gas and oxygen gas. Alternatively, gasoline vapors or the like are present in the chamber as an explosive gas. In one alternative, for example, the atmosphere is a mixture of dust and air, containing in particular oxygen or another oxidizing agent. At the very least, however, the atmosphere is such that an exothermic reaction, such as an explosion or at least ignition, occurs in the event of localized, excessive heating. The chamber is provided, for example, by means of a structure or the like, and its outer walls are made of stone or concrete, for example. Alternatively, the chamber is provided by a piece of furniture, such as a cabinet or the like. Preferably, the chamber is designed to be gas-tight and/or pressure-resistant.

An electric actuator can be located in the chamber. By means of the electric actuator, which is also simply referred to as the actuator, a specific action is carried out during operation, an electric current being required to carry out the action. In particular, the actuator is used to create the atmosphere, preferably any gas or a component of the gas. Alternatively, the gas is used, for example, to prevent a chemical reaction that would otherwise occur due to the operation of the actuator, or the actuator is used to further process the gas or a material during the processing or further processing of which the atmosphere is at least partially generated. For example, the chamber is a tank and the gas is produced, for example, by the evaporation of a liquid in the tank. The actuator here is a pump, for example. Preferably, however, the actuator is an electrolysis device, and when current is supplied, electrolysis of the water occurs, so that hydrogen gas and oxygen gas are produced.

A circuit breaker can be located in the chamber, the actuator and the circuit breaker being connected to each other by means of an electric line. When the actuator is energized, the electric current required for this is conducted through the circuit breaker and, in particular, monitored. In the event of an overcurrent, which is, for example, a certain multiple of the rated current used in normal operation, in the case of a short-circuit current or another malfunction, the circuit breaker is expediently actuated, so that the energizing of the actuator and thus its further operation are prevented. In particular, the circuit breaker comprises a terminal to which the electric line is connected, and the remaining end of the electric line is connected to the actuator.

The circuit breaker can have a hybrid switch which has a main current path with an isolating element and a secondary current path, connected in parallel to the main current path, with a semiconductor switch and a control circuit. The isolating element and the semiconductor switch are actuated by the control circuit. Preferably, the main current path and consequently also the secondary current path are routed to the terminals of the circuit breaker and in particular connected between them. If the circuit breaker is electrically conductive, therefore, is in the closed state, the electric current required to energize the actuator is conducted via the main current path.

Because the actuator and the circuit breaker can be arranged together in the chamber, the required length of the electric line, which is also referred to simply as a line, is relatively short, which is why manufacturing costs are reduced. When the circuit breaker is actuated manually, for example, by setting it to the electrically conductive state, the reaction of the actuator is also visible, making it easier to troubleshoot, for example.

For example, the circuit breaker can be attached to the actuator, which reduces the required installation space. Alternatively, the circuit breaker is attached to a wall in the chamber, for example, so that a separate replacement of the actuator and the circuit breaker is made possible, for example, for maintenance or in the event of a malfunction. Particularly preferably, however, the chamber has a control cabinet in which the circuit breaker is located. The control cabinet is expediently attached to a wall of the chamber. Mechanical damage to the circuit breaker is prevented hereby by the control cabinet. Due to the control cabinet, replacement of the circuit breaker is also facilitated, for example, if the requirements for the actuator have changed. Due to the control cabinet, installation of the circuit breaker in the chamber is also made easier. Preferably, the control cabinet is designed in such a way that it can accommodate a plurality of circuit breakers. In particular, a plurality of circuit breakers are disposed in the control cabinet, wherein there are, for example, a plurality of actuators in the chamber, at least some of which are structurally identical, for example. Expediently, one of the circuit breakers is assigned to each actuator. As a result, installation is simplified due to the control cabinet.

For example, the control cabinet can be impermeable to gas and/or pressure-resistant. Safety is thus increased. Particularly preferably, however, the control cabinet is not enclosed in a pressure-resistant manner. Consequently, the control cabinet does not meet in particular the requirements of the European standard “EN 60079-1 Explosive atmospheres—Part 1 Equipment protection by flameproof enclosure “d”.” In this way, the requirements for the control cabinet and therefore manufacturing costs are reduced. Certification is also not required, which in turn reduces manufacturing costs. In particular, it is possible to use any control cabinet. Expediently, the control cabinet is gas-permeable. Thus, heat dissipation from the control cabinet is facilitated, which is why local overheating is prevented that could, for example, lead to ignition of the explosive gas and/or destruction of the circuit breaker. It is possible further to use a standard component or at least an already existing design for the control cabinet, which is why manufacturing costs are reduced. Because due to the design of the circuit breaker, the formation of an arc is prevented when the circuit breaker is switched, therefore, when the switching state of the circuit breaker changes, namely, when the current flow through the circuit breaker is interrupted or started, there are essentially no requirements for the control cabinet with regard to suppressing an explosion.

In particular, a circuit breaker comprising a hybrid switch can be used to protect an actuator. In this regard, the circuit breaker is arranged in a potentially explosive environment, in particular a potentially explosive area. Thus, for example, an explosive/flammable fluid, such as a gas or a liquid, is located directly adjacent to the circuit breaker. The hybrid switch has a main current path with an isolating element and a secondary current path, connected in parallel to the main current path, with a semiconductor switch as well as a control circuit by means of which the isolating element and the semiconductor switch are actuated. Due to the design of the circuit breaker, the formation of an arc is avoided when the switching state of the circuit breaker changes, or its duration is at least relatively short. In this regard, the switching state is changed to protect the actuator, therefore, for example, if there is an overload or malfunction of the actuator. The potentially explosive environment in which the circuit breaker is used fulfills, for example, the definition of a zone 2/22 or preferably a zone 1/21 or particularly preferably a zone 0/20 in accordance with “Directive 1999/92/EC on minimum requirements for improving the safety and health protection of workers potentially at risk from explosive atmospheres.”

The refinements and advantages explained in connection with the circuit breaker are analogously also to be applied to the chamber/the use and to each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, are not limitive of the present invention, and wherein the sole figure schematically shows a chamber with an actuator and a circuit breaker.

### DETAILED DESCRIPTION

In the sole figure, a section of a chamber 2 is shown in a partial section schematically simplified in a perspective view. Chamber 2 is realized by means of a structure, not shown in detail, and has a number of walls 4, three of which are shown. Access to chamber 2 is possible via an airlock, not shown in detail. A control cabinet 6, which is shown semi-transparent, is attached to one of the walls 4. Control cabinet 6 is therefore located in chamber 2.

Two supply lines 8 extend into control cabinet 6, one of which is electrically contacted with a busbar 10 located in control cabinet 6. The other of supply lines 8 is electrically contacted with a circuit breaker 12 arranged therein. This supply line 8 is thereby connected to one of two terminals 14 of circuit breaker 12. Because circuit breaker 12 is disposed in control cabinet 6 located in chamber 2, circuit breaker 12 is consequently also located in chamber 2. A line 16 is connected to the other terminal 14 of circuit breaker 12 and is routed out of control cabinet 6 and to an (electrical) actuator 18, which is also located in chamber 2. In summary, actuator 18 and circuit breaker 12 are thus electrically connected by means of the (electric) line 16. Busbar 10 is connected to an additional line 20 in control cabinet 6, which line is also connected to actuator 18.

To operate actuator 18, it is supplied with electric energy, provided by means of supply lines 8, via the two lines 16, 20 and thus via control cabinet 6. The electric voltage present between the two supply lines 8 and therefore also between the two lines 16, 20 is greater than 400 V and, in the example shown, is the same as 650 V. The electric current carried by lines 8, 16, 20 is a direct current of 120 A.

When actuator 18 is in operation, it is used to electrolyze water, so that hydrogen gas (H2) and oxygen gas (O2) are produced. The hydrogen gas is at least partially introduced into chamber 2 and conducted out of chamber 2, which is otherwise gas-tight, to a tank or the like via an extraction system, which is not shown in detail. Due to the operation of actuator 18, an explosive gas 22, namely, hydrogen gas mixed with small quantities of oxygen gas, thus forms in chamber 2. Control cabinet 6, in which circuit breaker 12 is located, is not enclosed in a pressure-resistant manner and is gas-permeable, so that some of gas 22 can penetrate to circuit breaker 12. Circuit breaker 12 is thus arranged in a potentially explosive environment 24, and explosive gas 22 is located directly adjacent to circuit breaker 12, at least in part.

When actuator 18 is operated, the electric current required for this flows between the two terminals 14 of circuit breaker 12, which has a main current path 24 for this purpose, by means of which the two terminals 14 are electrically connected. In this case, one of the ends of main current path 24 is routed directly to one of the terminals 14, and the remaining end of main current path 24 is connected to additional terminal 14 via a sensor 26. During operation, sensor 26 is used to detect the electric current flowing through circuit breaker 12, therefore, the current flowing between the two terminals 14. Main current path 24 is a component of a hybrid switch 28, which has a secondary current path 30 which is connected in parallel to main current path 24 and is thus also directly electrically connected to one of the terminals 14. Secondary current path 30 is also connected to the remaining terminal 14 via sensor 26.

Main current path 24 has an isolating element 32, which is designed as a contactor or relay. Isolating element 32 is electrically connected in series to an additional semiconductor switch 34, which is designed as a MOSFET. The additional semiconductor switch 34 is selected in this case in such a way that it only has low electrical losses when it is electrically conductive, therefore, closed. The maximum electric voltage to be switched by the additional semiconductor switch 34 is therefore limited.

Secondary current path 30 has a semiconductor switch 36, which is also a MOSFET. The maximum electric voltage that can be switched by means of semiconductor switch 36 is increased in comparison to additional semiconductor switch 34, which is why the losses that occur are increased when an electric current is conducted by means of semiconductor switch 36. An additional isolating element 38, which is designed as a relay, is electrically connected in series to semiconductor switch 36.

In summary, both main current path 24 and secondary current path 30 each have one of the isolating elements 32, 38 and one of the semiconductor switches 34, 36, which are each electrically connected in series. In this case, the components corresponding to one another are not structurally identical. The two isolating elements 32, 38 are each formed galvanically isolating when they are in the electrically non-conductive state, therefore, when they are open. The two isolating elements 32, 38 are mechanical switching elements in each case, whereas semiconductor switches 34, 36 are electric switching elements and not galvanically isolating.

Isolating elements 32, 38 and semiconductor switches 34, 36 are actuated by means of an actuating circuit 40 of hybrid switch 28, so that actuating circuit 40 can be used to set each of these, at least in principle independently of one another, to the electrically conductive or electrically non-conductive state. Control circuit 40 is supplied with electric energy via a supply connection, not shown in detail, and is connected to sensor 26 in terms of signal technology.

In addition, control circuit 40, just like main current path 24, 30 and sensor 26, is arranged in a housing 42 of circuit breaker 12, which is made of a plastic. Consequently, isolating element 32, semiconductor switch 36, and control circuit 40 are enclosed by housing 42. Thus, the individual components are protected from mechanical damage. However, housing 42 is not enclosed in a pressure-resistant manner and is designed to be gas-permeable, so that gas 22 in environment 24 can also penetrate into the interior of housing 42.

If actuator 18 is operated, isolating element 32 and additional semiconductor switch 34 are in the electrically conductive state. In contrast, semiconductor switch 36 is in the electrically non-conductive state and additional isolating element 38 is in the electrically conductive state, for which a corresponding actuation takes place by means of actuation circuit 40. Thus, the electric current flowing between the two terminals 14 is conducted via sensor 26 and only via main current path 24, whereas no electric current flows via secondary current path 30. The losses occurring in this case in circuit breaker 12 are relatively low, because the losses occurring in the mechanical switch used as isolating element 32 are negligible and additional semiconductor switch 34 is selected accordingly. The low ohmic losses in hybrid switch 28 lead to heating of gas 22 located therein, which can flow out of housing 42, resulting in heat dissipation. Local overheating in circuit breaker 12 is thus prevented, which could otherwise lead to an explosion of gas 22.

The flowing electric current is monitored by sensor 26. If the flowing electric current exceeds a certain limit value for a certain period of time, namely, four times the rated current, therefore, 480 A, control circuit 40 determines that there is an overcurrent. This is caused, for example, by a malfunction of actuator 18 or by a short circuit between the two lines 16, 20. To prevent further damage to actuator 18, contamination of gas 22, and ignition of gas 22, it is necessary to interrupt the operation of actuator 18. Circuit breaker 12 is therefore used to protect actuator 18 in the potentially explosive atmosphere 24.

To interrupt the current flow through circuit breaker 12 when the overcurrent or another triggering event, such as a short circuit, occurs, additional isolating element 38 is first set to the electrically conductive state by means of control circuit 40, if it is not yet in the electrically conductive state. Subsequently, semiconductor switch 36 is set to the electrically conductive state, so that the electric current previously conducted exclusively via main current path 24 can also commutate at least partially to secondary current path 30. In other words, part of the electric current conducted via circuit breaker 12 is now also conducted via secondary current path 30.

The additional semiconductor switch 34 is then opened, so that the electric current flow via main current path 24 is interrupted. Because secondary path 30 is electrically conductive, the electric current now flows through it. The resulting electric voltage between terminals 14 is thus slightly increased due to the increased resistance of the components of secondary path 30. However, such an electric voltage can be easily switched using additional semiconductor switch 34. Following this, semiconductor switch 36 is opened, so that the electric current flow via secondary current path 30 is now also interrupted. Thus, an electric current no longer flows between terminals 14. Following this, the two isolating elements 32, 38 are then opened, which is why the two terminals 14 are electrically isolated from each other.

Subsequently, no more electric current flows to actuator 18, at least no longer via line 16, and the operation of actuator 18 is stopped. In addition, actuator 18 is electrically isolated from one of the supply lines 8 due to circuit breaker 12. In summary, circuit breaker 12 is set to the electrically non-conductive state. In this case, no arcing occurs when circuit breaker 12 is brought from the electrically conductive to the electrically non-conductive state, so that circuit breaker 12 can be used safely to protect actuator 18 despite the potentially explosive environment 24.

The invention is not limited to the exemplary embodiment described above. Rather, other variants of the invention can also be derived herefrom by the skilled artisan, without going beyond the subject matter of the invention. Particularly, further all individual features described in relation to the exemplary embodiment can also be combined with one another in a different manner, without going beyond the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A circuit breaker for operation in a potentially explosive environment, the circuit breaker comprising:
a hybrid switch that has a main current path with an isolating element and a secondary current path connected in parallel to the main current path;
a semiconductor switch;
a control circuit via which the isolating element and the semiconductor switch are actuated.

2. The circuit breaker according to claim 1, further comprising a housing via which the isolating element, the semiconductor switch, and the drive circuit are enclosed.

3. The circuit breaker according to claim 2, wherein the housing is not enclosed in a pressure-resistant manner.

4. The circuit breaker according to claim 1, wherein the secondary current path has an additional isolating element that is electrically connected in series to the semiconductor switch and actuated by the control circuit.

5. The circuit breaker according to claim 1, wherein the main current path has an additional semiconductor switch that is electrically connected in series to the isolating element and actuated by the control circuit.

6. A chamber that is adapted to be filled with an explosive atmosphere, the chamber comprising:
an electric actuator; and
the circuit breaker according to claim 1,
wherein the actuator and the circuit breaker are electrically connected via an electric line.

7. The chamber according to claim 6, further comprising a control cabinet in which the circuit breaker is arranged.

8. The chamber according to claim 7, wherein the control cabinet is not enclosed in a pressure-resistant manner.

9. The circuit breaker according to claim 1, wherein the circuit breaker protects an actuator in a potentially explosive environment.
